(19) United States
(12) Patent Application Publication
(10) Pub. No.: US 2018/0336282 A1
(43) Pub. Date: Nov. 22, 2018

(54) SYSTEM AND METHOD FOR PROVIDING PERSONALIZED NEWS FEED TO A USER

(71) Applicant: Inshorts Medialabs Private Limited, Delhi (IN)

(72) Inventors: Anunay PANDEY, Noida (IN); Naveen KAUSHIK, Noida (IN); Avijit VAJPAYEE, Noida (IN); Rahul TIBREWAL, Noida (IN); Sourav DE, Noida (IN); Kamal BANGA, Noida (IN); Azhar IQUBAL, Noida (IN); Deepit PURKAYASTHA, Noida (IN); Manish BISHT, Noida (IN); Ravi SINGH, Noida (IN)

(73) Assignee: Inshorts Medialabs Private Limited

(21) Appl. No.: 15/601,057

(22) Filed: May 22, 2017

(51) Int. Cl. G06F 17/30

(52) U.S. Cl. CPC G06F 17/30867

(57) ABSTRACT

The present disclosure is related to a system and method for providing personalized news feed on a mobile application installed in a computing device of a user. The said mobile application includes a computer readable instruction for accessing the news feed. The computing device is communicably coupled to a digital content server which stores a plurality of news contents pre-stored in the said digital content server. The method comprises receiving user activity data at the digital content server from the computing device, determining user preferences for one or more category of news content depending upon the user activity data, ranking the one or more news content to compile the news feed, and transmitting the news feed to the computing device of the user wherein the transmittal of the news feed takes place on a request from the computing device.

### FIELD OF THE DISCLOSURE

The field of the present disclosure relates to system and method for providing personalized news feed on a mobile application installed in a computing device of a user. The said mobile application comprising computer readable instructions for accessing the news feed. The computing device being communicably coupled to a digital content server which stores a plurality of news contents pre-stored in the said digital content server. More specifically, the present disclosure relates to system and method for providing personalized news feed comprising a plurality of news contents on the computing device of a user.

### BACKGROUND OF THE DISCLOSURE

In this 21^{st} century, use of mobile phones and other computing devices has become very common to the mankind. There has been a tremendous increase in the number of mobile phone users across the world. Such devices have become an integral part of the lives of human beings.

These computing devices find varied usage such as playing games, surfing internet, capturing pictures, social media networking, and much more. Among the varied usages of these devices, people have become more interested towards updating themselves with news contents. Easy availability of internet and adequate connectivity with mobile devices, people want to remain updated with the latest happenings around the world. In this knowledge driven world, the thirst for gaining knowledge has been increasing among people. Such kind of knowledge may include any type of information like information related to science, politics, interesting facts, health, and many more.

There are many content service providers available in the market for providing digital content which a user/person would like to view, read, watch and share. Content service providers provide a variety of content, be it the current news related to business, sports, politics, technology, entertainment, science and much more. There are endless possibilities of categories of news contents which a user would like to read.

Especially, there has been a growing number of content service providers who aim at providing news content quickly and in the most efficient manner. The present disclosure has been made by one of the pioneers of providing short news content to users. They are creators of a new category of news content, called short news content, wherein concise 60 words summary of long news contents are provided to users using their mobile applications installed on smart phones.

This new category of news contents is growing popular among the users. The users find it attractive because of many reasons. One of the important reasons is the ease of reading the short and to the point news rather than lengthy opinionated analysis. This saves a lot of time for the user, and in the fast paced and short retention times it is highly welcome.

Furthermore, there are times when a user prefers to read news contents which are of interest to him. One user may be interested in news content related to sports while the other user may be interested in news content related to politics. Therefore, there arises a need for providing personalized news feed to each user so that each user can read news content of his interest. Also, there is a need to provide systems and method so that the users view the news content in totality and is not required to go through hyperlinks for reading/viewing the content.

### SUMMARY OF THE DISCLOSURE

The general purpose of the present disclosure is to provide a system and method for providing personalized news feed comprising a plurality of news content to a user having a computing device.

To achieve the above objectives and to fulfill the identified needs, in one aspect, the present invention provides a computer implemented method for providing personalized news feed in a mobile application installed in a computing device of a user, wherein the said mobile application comprises computer readable instructions for accessing the news feed. The computing device is communicably coupled to a digital content server which stores a plurality of news contents pre-stored in the said digital content server.

In an aspect of the present disclosure, the computer implemented method comprises receiving user activity data at the digital content server from the computing device wherein the user activity data is collected at the computing device, determining user preferences for one or more category of one or more news content depending upon the user activity data, wherein the one or more news content is taken from a plurality of news contents pre-stored in a database at the digital content server, ranking the one or more news content to compile the news feed, ranking being done on basis of user preferences for each of the one or more news content, transmitting the news feed to the computing device of the user wherein the transmittal of the news feed takes place on a request from the computing device.

In an aspect of the present disclosure, the user activity data comprises a unique device_id associated with the computing device and content_id associated with each of the news contents accessed on the computing device.

In an aspect of the present disclosure, the user activity data comprises time spent for previously accessed news content.

In an aspect of the present disclosure, the user activity data comprises information such as whether previously accessed news content has been shared or liked or broadcasted via the computing device.

In an aspect of the present disclosure, determining the user preferences comprises generating user affinity for a category of one or more news content.

In an aspect of the present disclosure, ranking of the one or more news contents depends upon an editor score wherein the editor score is provided by an editor team having human interfaces.

In an aspect of the present disclosure, the ranking of the one or more news contents is done on basis of an expected time spent for one or more news content for the user.

In an aspect of the present disclosure, the expected time spent for one or more news content for the user is calculated on the basis of actual time spents by users belonging to pools of users.

In an aspect of the present disclosure, the pool of users is created on the basis of users sharing similar interest in categories of news contents.

In yet another aspect of the present disclosure, a system for providing personalized news feed on a computing device of a user, the computing device being communicably coupled to a digital content server, the digital content server comprising one or more processors capable of executing instructions comprising receiving user activity data at the digital content server from the computing device wherein the user activity data is collected at the computing device, determining user preferences by a Preference Determiner for one or more category of one or more news content depending upon the user activity data, wherein the one or more news content is taken from a plurality of news contents pre-stored in a database at the digital content server, ranking the one or more news content by a Ranking module to compile the news feed, ranking being done on basis of user preferences for each of the one or more news content, transmitting the news feed by a Transmitting module to the computing device of the user wherein the transmittal of the news feed takes place on a request from the computing device.

This together with the other aspects of the present disclosure along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates an environment for the implementation of the method for providing personalized news feed to a user, according to an embodiment of the present disclosure;

FIG. 2 illustrates an illustration of the software application with a news content as displayed on the computing device of the user, according to an embodiment of the present disclosure;

FIG. 3 illustrates a flowchart explaining the computer implemented method for providing personalized news feed to a user, according to an embodiment of the present disclosure;

FIG. 4 provides a flow diagram for finding an expected time spent of a user, according to an embodiment of the present disclosure;

FIG. 5A provides an illustration for analysis of user preference on a time based criteria, according to an embodiment of the present disclosure;

FIG. 5B provides another illustration for the analysis of user preference on a time based criteria where one news content may belong multiple categories, according to another embodiment of the present disclosure;

FIG. 6 provides an illustration for the analysis of user preferences wherein the user accesses the link for reading the full story of the news content belonging to a particular category, according to an embodiment of the present disclosure;

FIG. 7 provides an illustration for the analysis of user preferences wherein a user broadcasts a news content of a particular category to other users, according to an embodiment of the present disclosure;

FIG. 8 provides a conceptual illustration for the analysis of user preferences wherein a user likes or shares a news content belonging to a particular category over social media platforms, according to an embodiment of the present disclosure;

FIG. 9 illustrates an exemplary news feed compiled on the basis of the disclosed algorithms, according to an embodiment of the present disclosure; and

FIG. 10 illustrates the architecture of a computing device, according to an embodiment of the present disclosure.

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced content.

The terms “having”, “comprising”, “including”, and variations thereof signify the presence of a component.

The term “communication network” relates a network of computing devices which are capable of communicating with each other via the internet.

The term “computing device” relates to electronic devices such as mobile phones, smart phones, laptops, desktops, tablets and the like.

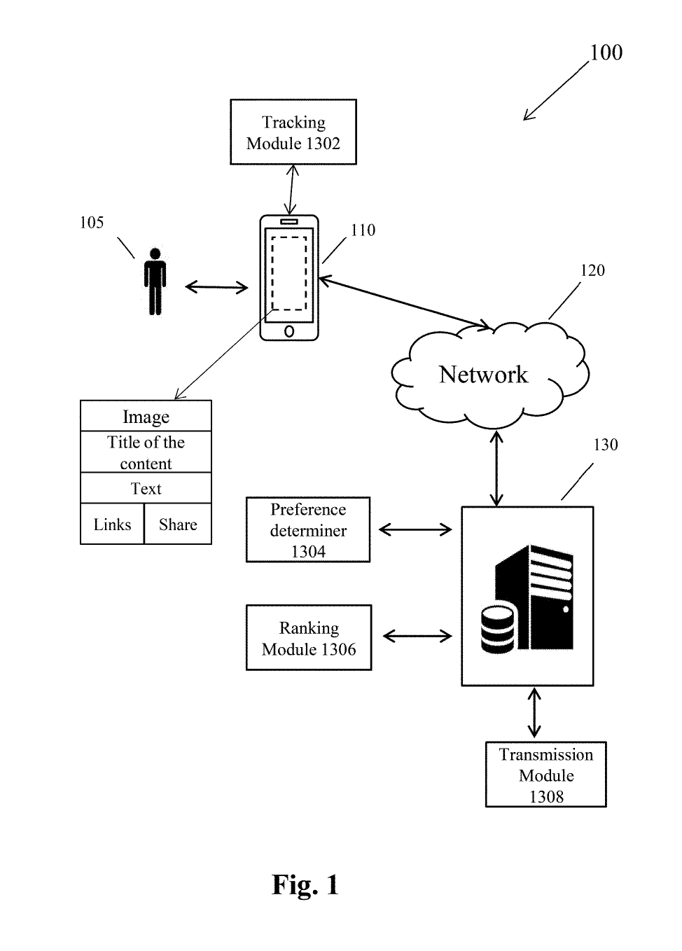

The present disclosure relates to a method for providing personalized news feed to a computing device of a user. The user is subscribed to services provided by a content service provider and has software application installed in the computing device capable of accepting and presenting the digital content in a predefined digital format. The services being provided are short news content or other like services, where the server provides news content in form of short summary including a contextual image, a title and a limited word summary of a larger news item. The said systems and methods shall now be explained in conjunction with FIGS. 1 to 10.

The terms “digital content server” and “content service provider” are being used interchangeably throughout the description.

The terms “digital content” and “news content” are being used interchangeably throughout the description.

Referring to FIG. 1, there is shown an environment representing the various components involved in the implementation of the method for providing personalized news feed to a user on his computing device.

There is shown a user 105, a computing device 110, digital content server 130 at the end of a content service provider providing the short news content or other like services, and a communication network 120.

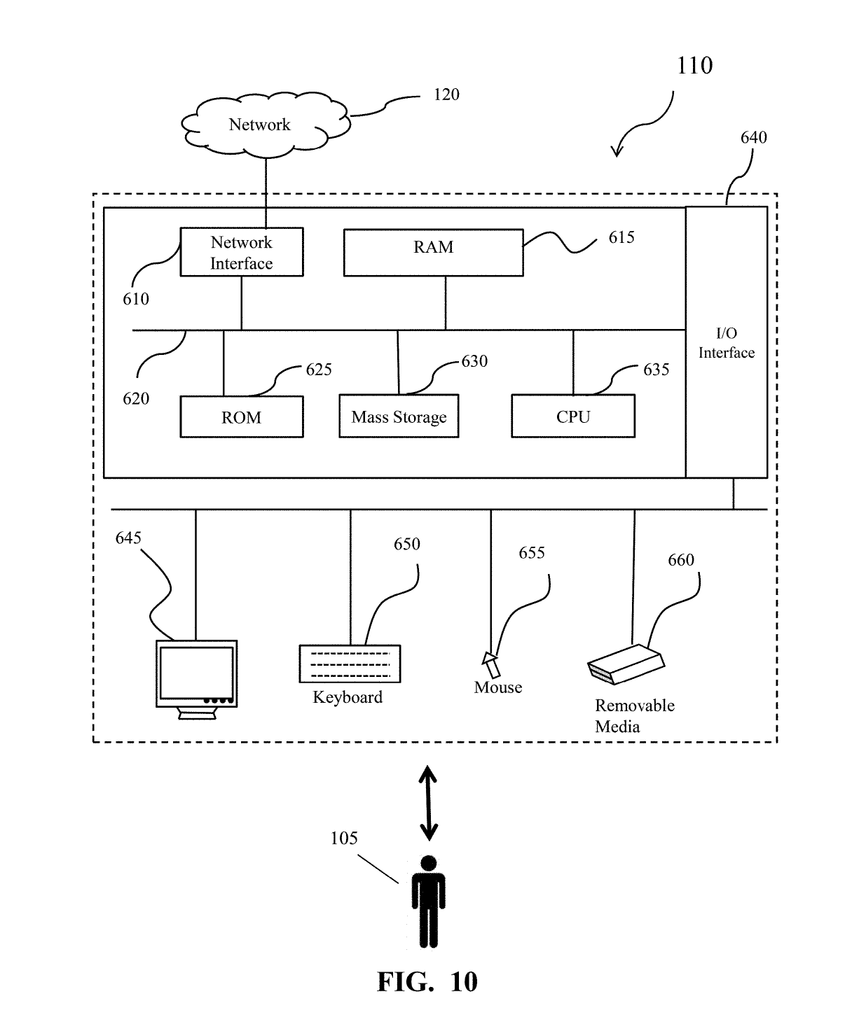

It will be apparent to a person skilled in the art that the computing devices 110 herein refer to any processing device, and may include mobile phones, smart phones or PDAs, Tablet computers and the like. Such computing devices comprise a memory, a display screen, an input/output unit and a processor capable of executing instructions for accessing a digital content broadcasted by the digital content server. These computing devices include a software application capable of executing the news content provided by the content service provider. In one embodiment, a computing device is a smart phone, such as iPhone, with the mobile phone application pre-installed or custom installed by the subscribers. The architecture of such computing device 110 is explained in details with reference to FIG. 10 later.

Referring again to FIG. 1, the digital content server 130 is at the content service provider end and is adapted to generate and transmit digital contents to the computing device of a user.

In an embodiment of the present disclosure, the digital content server 130 is adapted to automatically generate the news content 200 using artificial intelligence algorithms. In this regard, it is explained that the artificial intelligence algorithms may be used to create short news contents from lengthy news articles available on the internet.

As aforesaid, these days various kinds of news contents are available on the web. The news content may relate to any kind of information such as news relating to sports, world, politics, technology, entertainment, science and much more. The news content may also relate to any interesting facts around the world. Such kind of information is available in vast quantities on the World Wide Web.

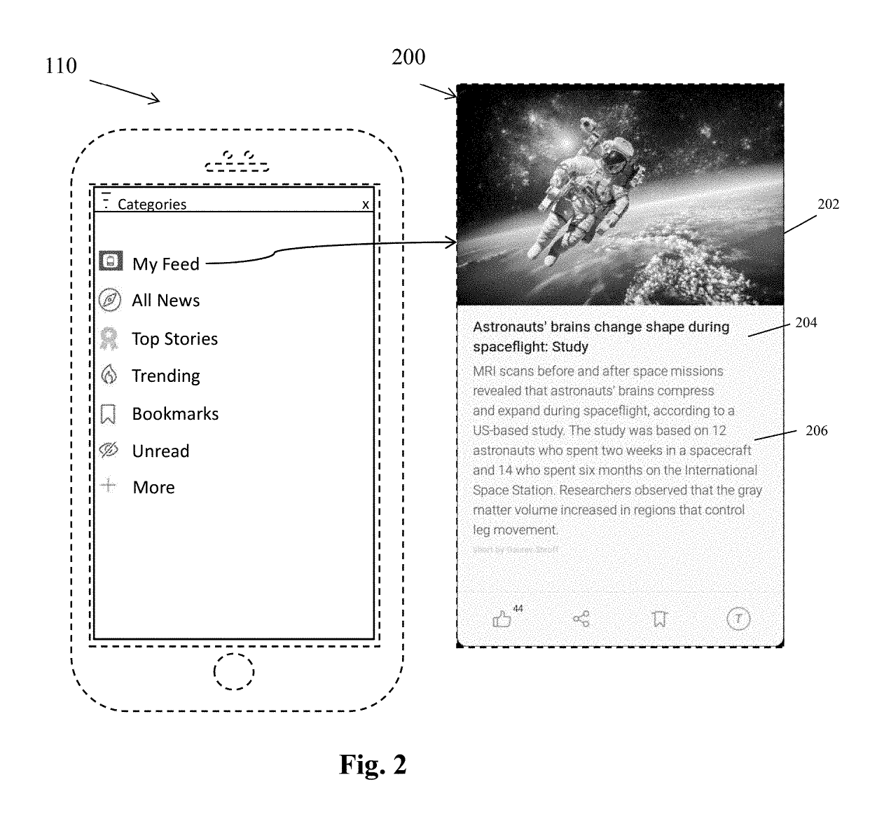

However, it will be appreciated by a person skilled in the art that such information is generally in the form of long reports reading which is time consuming for a user. There are many details in these reports, which may be irrelevant to the user. A user may only be interested to read the relevant portion of such information. Therefore, these artificial intelligence algorithms may be adapted to generate a summarized content (short news content) automatically by parsing the information to produce the short news content based on computing algorithms. The short news content may be in a predefined format (picture, headline and summary) as shown in FIG. 2. These kinds of short news content 200 are gaining popularity.

In an embodiment, the present disclosure employs human interface who hold expertise in redacting and shortening long article into short and precise one to make the news content 200, as shown in FIG. 2.

Referring to FIG. 2, the digital content is a short news content 200 which comprises a summary of larger news content. Specifically, such short news content 200 comprises an image 202, title of the news 204, and the summary of the news 206 in a preset number of words or less.

It should be understood by the person skilled in the art that the digital content 200 as shown and explained with reference to FIG. 2 should not be construed as a limitation to the present invention. The systems, methods and algorithms disclosed may be used to present digital content in any form of textual content, an image content, a video content, an audio content, or a Graphics Interchange Format (GIF).

The digital content server is further adapted to store each of the news content 200 in a database with a unique content_id associated with each news content 200. This unique content_id is created by the digital content server 130 for each of the news content 200 as and when required.

It will be appreciated to those skilled in the art that a user may read/view the digital content via execution by a software/mobile application which is pre-installed on the computing devices 110. Such software application may be compatible to any of the operating systems known in the art, such as Android OS, Windows OS or iOS, and may be downloaded on the computing devices 110 from application stores such as Google Play Store, App Store.

Each computing device 110 is assigned a specific and unique device_id by the digital content server 130 and this device_id is stored in a database at the digital content server 130. An example is provided in the below table:

| User | Device_id | Mobile |
|---|---|---|
| John | John123 | XXXXXXXXXX |
| Alex | Alex456 | YYYYYYYYYY |
| Sam | Sam789 | ZZZZZZZZZZ |

Once the software application is installed in the computing devices 110, there is provisioning of a Tracking module which is adapted to track the various news contents being accessed by the user on a computing device 110. Upon tracking, the computing device 110 is configured to collect the user activity data and send it to the digital content server 130. The user activity data comprises the device_iD and the list of one or more content_id associated with the news contents 200 accessed on the computing device by a user.

In an embodiment, the user activity data comprises the time spent for reading news content 200.

In another embodiment, the user activity data comprises information such as whether news content 200 has been shared over social media networks such as Facebook, LinkedIn, Twitter, etc. or the news content 200 has been liked by a user.

In an embodiment, the user activity data comprises information related to the number of times a specific category of news contents have been accessed via the computing device by the user.

In an embodiment, the user activity data comprise information whether the link to reading the full news story has been accessed via the computing device.

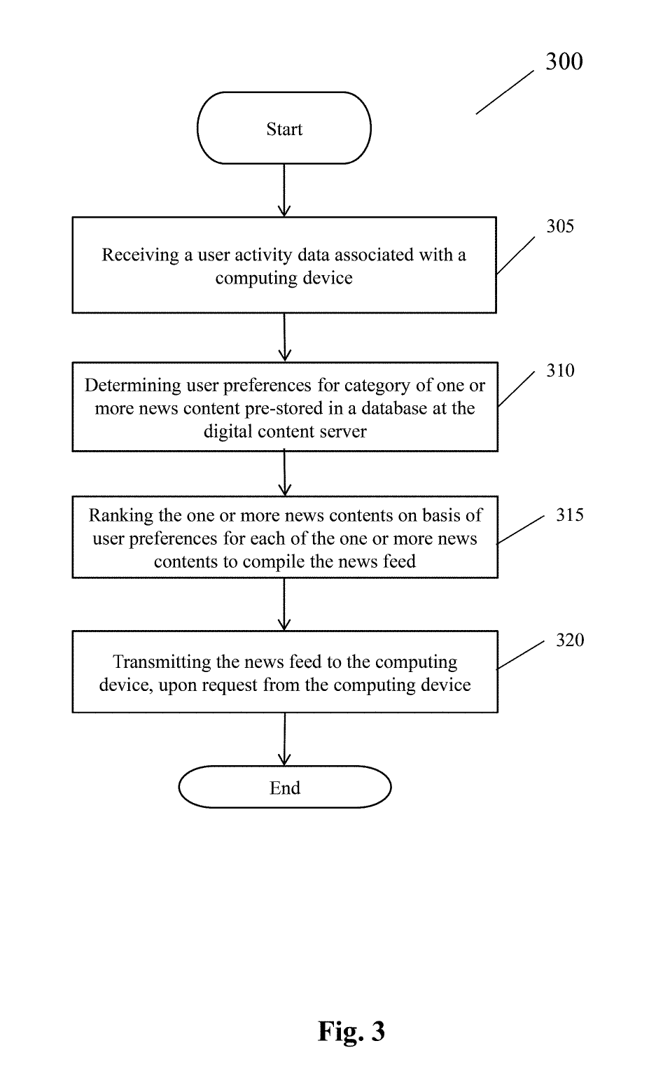

At the end of the digital content server 130, there is provided an Analyzing module 1304, which is adapted to analyze the user activity data in order to determine the user affinity for similar type of news contents. In this context, it will be apparent to a person skilled in the art that the similar type of news contents and other news contents are stored in a database at the digital content server. The said analysis will be explained in conjunction with FIG. 3 of the accompanying drawings.

In an embodiment of the present disclosure, the preference determiner 1306 is adapted to determine the user preferences on the basis of user activity data. Furthermore, the determination of user preferences comprises an affinity generator which is capable of generating user affinity for a category of news contents 200. User affinity can be defined as a parameter which determines the chances of a user reading particular news content depending on a thorough analysis of the history of news contents previously accessed by the user via computing device.

In an embodiment of the present disclosure, the Ranking module 1308 is adapted to rank the news contents 200 depending upon user affinity to compile the news feed for each of the users 105, thereby keeping the most relevant news content on the top.

In an embodiment of the present disclosure, the Transmission module 1310 is adapted to transmit the compiled news feed on the computing devices 110 of the users 105. The various methodologies for such ranking of news contents in order to compile a news feed for a user are being explained in conjunction with FIG. 3 of the accompanying drawings.

The computing device and the digital content server are communicably coupled to each other via the internet or a network of computers or other sources of digital communication.

Now referring to FIG. 3, there is shown a flowchart for the computer implemented method 300 for providing personalized news feed comprising a plurality of news contents 200 to a user 105 on his computing device 110.

In an embodiment, the computer-implemented method 300 comprises a processor executable set of instructions capable of determining the user preferences and compiling a personalized news feed for a user.

Referring to the flowchart as provided in FIG. 3, the method starts at step 305, where the user activity data is received at the end of the digital content server 130. The user activity data is being transmitted from the computing device 110. The software application installed at the computing device for accessing the news content comprises a Tracking Module 1302. The said Tracking Module 1302 is adapted to track the user activity with respect of news contents being accessed by the user via the said software application. Moreover, the said Tracking Module 1302 is synchronized with the digital content server for providing the user activity data to the server.

The user activity data relates to the information about the activities of the user accessing the plurality of news contents being provided by the digital content server 130 in a dynamic manner. The user activity data is being tracked, collected and transmitted to the digital content server 130 via the computing device 110.

In an embodiment, the news contents accessed on a computing device by a user is tracked all the time and the user activity data is collected and transmitted to the digital content server 130. This may however vary and should not be taken as a limitation of the present invention. It may be a possibility that the user activity data is collected and transmitted at certain intervals of time.

Additionally, the digital content server 130 is configured to identify the user activity data on the basis of device_id associated with the computing device from which the user activity data has been received. The user activity data comprises the device_id and the list of one or more content_id associated with the news contents 200 accessed on the computing device by a user.

In an embodiment, the user activity data comprises the time spent for reading a news content 200.

In another embodiment, the user activity data comprises information such as whether news content 200 has been shared over the social media such as Facebook, LinkedIn, Twitter, etc. or the news content 200 has been liked by a user.

In an embodiment, the user activity data comprises information related to the number of times a specific category of news contents have been accessed via the computing device by the user.

In an embodiment, the user activity data comprise information whether the link to reading the full news story has been accessed via the computing device.

The digital content server 130 is adapted to maintain a database comprising the user activity data which is automatically updated on a regular basis.

At step 310, the method 300 is adapted to determine user preferences on the basis of the received user activity data. As mentioned before, the user activity data comprises the information related to previously accessed news contents via the computing device. The previously accessed plurality of news contents may belong to any category. The categories include but not limited to sports, world, politics, technology, entertainment, science and much more. The plurality of news contents may also relate to any interesting facts around the world.

At the end of the digital content server, there is provided a Preference Determiner 1304 which is capable of determining the user preferences.

A modelling technique is used and fixed set of categories {c₁, c₂, c₃, . . . , cₘ} is created and a model M. This model M analyses the content of a news content A and outputs the weights corresponding to each of those categories as {w₁, w₂, w₃, . . . , wₘ}, where each wᵢ tells how much the news content A falls in cᵢ category.

In a hypothetical situation, consider news contents N₁, N₂, N₃, . . . , Nₖ being accessed via a computing device and time-spent on those news contents are T₁, T₂, T₃, . . . , Tₖ respectively. Each time spent Tᵢ is converted to a rating Rᵢ using the following formula:

Ri=min(max(0,Ti),25)

It may happen in certain scenarios, when a user only reads the title of the news content and switches to another news content. Furthermore, a user may read only halfway through the news and switches to another news content. In such cases, the time spent at news content vastly differs.

Applying model M on these news contents gives a weight-vector corresponding to categories, i.e.

N₁˜{w₁₁,w₁₂,w₁₃, . . . w₁ₘ}

N₂˜{w₂₁,w₂₂,w₂₃, . . . w₂ₘ}

N₃˜{w₃₁,w₃₂,w₃₃, . . . w₃ₘ}

So, wᵢⱼ represents weight of jₜₕ category in Nᵢ news content. The model M represents the LLDA algorithm for finding the weightage of each category for particular news content. LLDA stands for Labeled Latent Dirichlet Allocation. It will be apparent to a person skilled in the art that the LLDA is a probabilistic graphical model which describes a process for generating a labeled document collection. In the present disclosure, news content is inputted in the LLDA model and the said model outputs weights w for each category of the news content. The weightage of each category is further used in the calculation of user affinity for each category of news content.

A sub-routine called as an affinity generator of the preference determiner 1304 is adapted to generate a user-affinity Aᵤⱼ for category cⱼ according the following computation:

$${A}_{uj} = \frac{{\sum }_{p = 0}^{k} {w}_{pj} {R}_{p} I ( {w}_{pj} )}{{\sum }_{p = 0}^{k} {w}_{pj} I ( {w}_{pj} )} where I ( x ) = 1 if x \geq TH else 0$$

Here, TH is a threshold which filters out the category for news content in the above formula.

User-Affinity of the user u for categories is thus stored as (Aᵤ₁, Aᵤ₂, Aᵤ₃, . . . , Aᵤₘ) at the digital content server 130.

In order to further clarify the above, in an exemplary embodiment, the following explanation is being provided. This should however, not be construed as a limitation to the present disclosure.

### Example

Suppose there are 5 News contents N₁, N₂, N₃, N₄, N₅ with time spents (in seconds) as 5, 34, 12, 3, 8 on them by user u respectively. Further, suppose there are three categories c₁, c₂, c₃.

The news contents N₁, N₂, N₃, N₄, N₅ are taken as input by the pre-trained LLDA model and the said model outputs weights corresponding to pre-defined categories c₁, c₂, c₃.
Let them be as follows:

N₁=(0.8,0.1,0.1)⇒(w₁₁,w₁₂,w₁₃)

N₂=(0.05,0.85,0.1)⇒(w₂₁,w₂₂,w₂₃)

N₃=(0.4,0.5,0.1)⇒(w₃₁,w₃₂,w₃₃)

N₄=(0.9,0.01,0.09)⇒(w₄₁,w₄₂,w₄₃)

N₅=(0.1,0.05,0.85)⇒(w₅₁,w₅₂,w₅₃)

Now, the Timespents are converted to Ratings R₁ as below:

R₁=min(max(0,T₁),25)=5

R₂=min(max(0,T₂),25)=25

R₃=min(max(0,T₃),25)=12

R₄=min(max(0,T₄),25)=3

R₅=min(max(0,T5),25)=8

Assume, TH in the formula as 0.1.
Applying the formula for calculating user affinity for each of the categories:

$${A}_{uj} = \frac{{\sum }_{p = 0}^{k} {w}_{pj} {R}_{p} I ( {w}_{pj} )}{{\sum }_{p = 0}^{k} {w}_{pj} I ( {w}_{pj} )} where I ( x ) = 1 if x \geq TH else 0$$

$${A}_{u 1} = \frac{0.8 + 5 + 0 + 0.4 * 12 + 0.9 * 3 + 0.1 * 8}{0.8 + 0.4 + 0.9 + 0.1} = 5.59$$

$${A}_{u 2} = \frac{0.1 * 5 + 0.85 * 25 + 0.5 * 12 + 0 + 0}{0.1 + 0.85 + 0.5} = 19.13$$

$${A}_{u 3} = \frac{0.1 * 5 + 0.1 * 25 + 0.1 * 12 + 0 ++ 0.85 * 8}{0.1 + 0.1 + 0.1 + 0.85} = 9.56$$

Therefore, the user affinity for each of the categories c₁, c₂ and c₃ are taken as 5.59, 19.13 and 9.56 respectively.

Hence, a higher time spent on a particular category of news contents indicates the intention of the user to read similar news contents. There may be situations when particular news content may belong to multiple categories. For example, a news content titled “Google restructures itself as Alphabet” may belong to Technology, Finance and Google. In such scenarios, it is important to analyze the categories of news contents which a user might be interested in reading. An average of the time spents in each category of news content is taken into consideration while analyzing the user preferences.

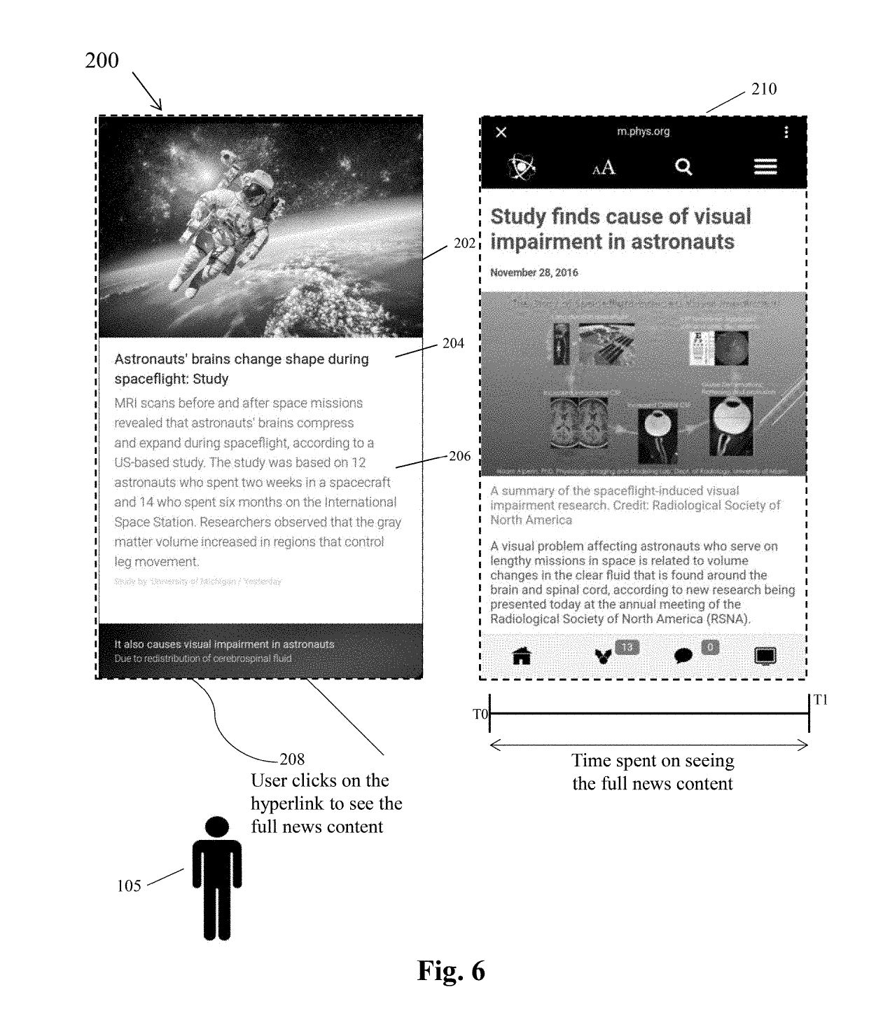

In an exemplary embodiment, if a user is interested in certain news, the user may spend more time reading the news content and may also prefer to read the full story to know the entire news. For example, if a user is interested in technology news, the user may read the news related to the launch of iPhone 7. It is more likely that the user may want to read more on the said topic to know the technical specification of the iPhone 7. This may tempt the user to access the link to read the entire article for iPhone 7. The said link/URL may be from a third party or another news provider. A pictorial representation of such an activity of the user has been shown in FIG. 6 of the accompanying drawings.

It will be appreciated by those skilled in the art that it is more likely that if a user has read the full story of the news by accessing the original link, the user is more interested in reading such news contents which are of particular categories. Hence, this indicates positive preferences towards user reading similar news contents.

In another embodiment, whether the user has liked or shared the news contents on a social media platform is another positive intention of the user for sharing news contents belonging to that category.

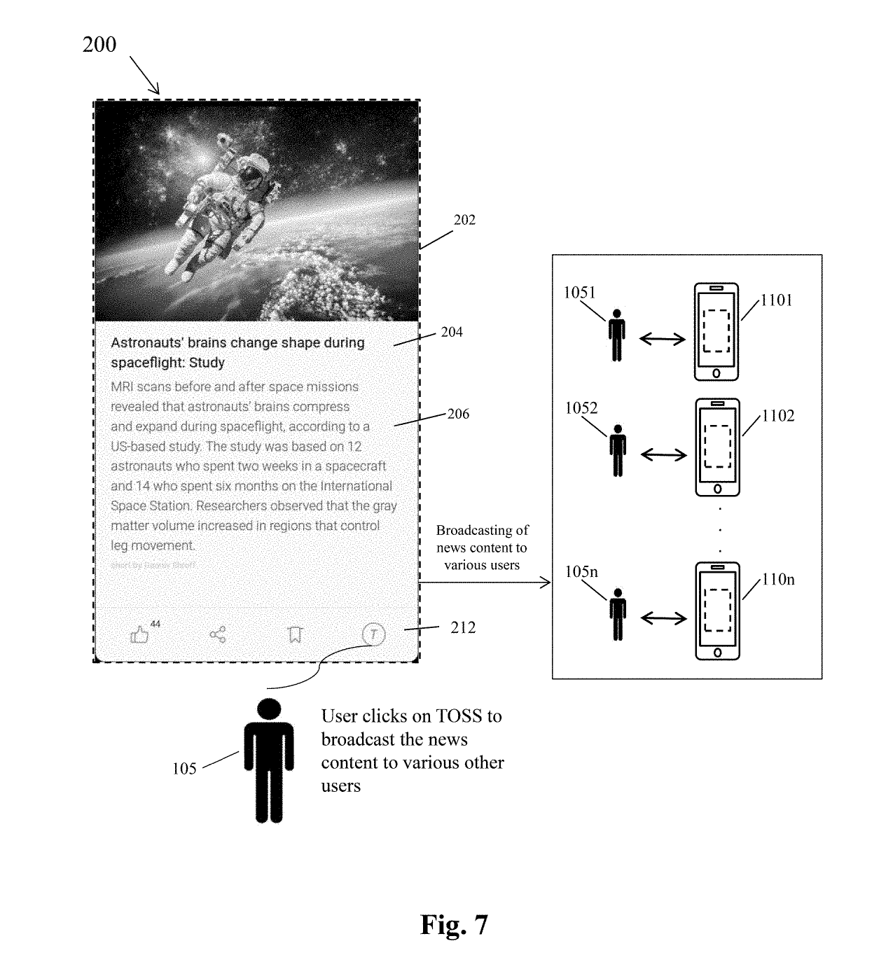

It will again be appreciated by persons skilled in the art that sharing or liking particular news content by a user indicates a positive preference of the user towards reading similar news contents, and accordingly the method is configured to provide more news content from the category of news contents shared by the user. There are scenarios when the user wants to share particular news content with other users. Such sharing or liking of the news contents provide positive preference of the user wanting to read similar news contents. The conceptual understanding of the user preferences on the basis of sharing or liking of the news contents shall be explained in conjunction with FIGS. 7 & 8 of the accompanying drawings, where there is shown the user 105 broadcasting (as in FIG. 7) and sharing the news content 200 on multiple social media platforms 115, 117, 119, explained in details later.

Referring again to the method 300, once the user preferences are determined, the method 300 is adapted to rank the one or more plurality of news contents on the basis of relevance for transmitting to the computing device of a user. The ranking of the one or more news contents depends upon a number of criteria. Such ranking of the plurality of news contents is performed on the basis of various criteria as explained hereinafter.

In another embodiment, an estimated time which a user might spend with the news content is calculated. Such an estimation of time which a user might spend on news content defines higher chances of the user accessing the news content.

Such time prediction for news content Nᵢ which topic distribution comes out to be (wᵢ₁, wᵢ₂, . . . , wᵢₘ),

$$< {T}_{ui} >= \frac{{\sum }_{p = 0}^{m} {A}_{uj} {w}_{ij} I ( {w}_{ij} )}{{\sum }_{p = 0}^{m} {w}_{ij} I ( {w}_{ij} )} where I ( x ) = 1 if x \geq TH else 0$$

It has been observed over a period of time, even though there are smart and intelligent algorithms which are capable of determining the relevance of a news contents, there still remains a gap where there is a need for human interference in judging the importance or relevance of a news content. In such scenarios, the present disclosure involves the involvement of editorial team in judging the importance of news content for users.

In an embodiment of the present invention, an editorial team employing human interfaces provides an editor score to each news content. The ranking of the news contents in the news feed of the user is further dependent on the editor score provided by the editorial team.

Further, in addition to the plurality of news contents in the news feed, few of the best news contents from each topic are also added. News is a domain which like other media does involve personalization but it is unlike other media in the sense that it's vital to broadly cover major topics to show to a user. The selection of few news contents from each topic is done using editor score, given by the editor team. The editor team includes human experts who curate the news contents for various users.

Additionally, the editor team gives a flag to a news content which is deemed to be very important. Often the importance/relevance/impact of news cannot be found automatically from the content itself and human judgement is necessary, henceforth this score is critical. As an example a user might not have interest in sports but he/she will be shown news at top position if India wins an Olympic gold medal.

Additionally, in the present disclosure, clusters or pools of users are defined for predicting user preference on the basis of time spent by the pool of users for news content. It will be apparent to a person skilled in the art that such cluster of users is segmented using collaborative filtering technique. According to Collaborative Filtering technique, users and contents are segmented into clusters according to their past ratings. In this case, contents are news and ratings are same as time spent by each of the users. This learning is based on similar users of this user who have read both these news contents.

In an embodiment, the plurality of news contents compiled in the news feed are ranked on the basis on collaborative filtering. For example, two digital contents, such as “Apple launches new iPhone” and “iPhones makes 58% of Apple's Q4 revenue”. Both have “Technology” & “Apple” as topics but often time spent on these articles varies a lot with different users.

The actual time spent by few active users is taken as a signal of interest. Users interested in “Apple” & “iPhone” in general will spend much more time in the iPhone launch news while the niche user base interested in “Finance” & “Stock Market” will often find the latter one more interesting. The present method is adapted to take this signal of interest and predict the rank of a news content based on which pool of users does a user belong in.

Additionally, if there are two news contents with similar topic distribution or similar collection of topics, and then it is important to find out the weightage of each news content to choose which one should be presented to which user. For example, “India participated in Olympics” vs “India won 2 golds in Olympics”, both news contents have same categories, namely “Olympics” & “Sports” but they differ vastly in the importance, the latter one may be impactful for a particular user.

In addition to the above criteria for ranking of plurality of news contents in the news feed, there are personalized news contents being provided to the users. There are some news contents which don't have broad appeal but are very important to those who follow that particular topic, for example, “Google restructures itself as Alphabet”. Such news content deserves a personalized notification, a notification only to those who are interested in that topic, in this case, “Google”, “Technology” and “Finance”. The editor team marks such news content with a flag “Personalized Notification” and the algorithm matches this news' topic to those of each user's preferences and finds the list of users who are clearly and surely interested in at least one of all topics present in that news. Further, a notification is sent to this pool of users.

The various criteria for ranking the plurality of news contents in the news feed may include more criteria. This should not be construed as a limitation to the present invention. There may be other possible criteria for such ranking of news contents.

Referring again to the FIG. 3, once the ranking of the plurality of news contents is done and the news feed is compiled. It will be appreciated by person skilled in the art that the news feed so compiled is updated constantly depending upon the determination of user preferences. At step 325 of the method 300, whenever, a request is received at the digital content server, the news feed is transmitted to the computing device with the unique device_id as stored at the digital content server.

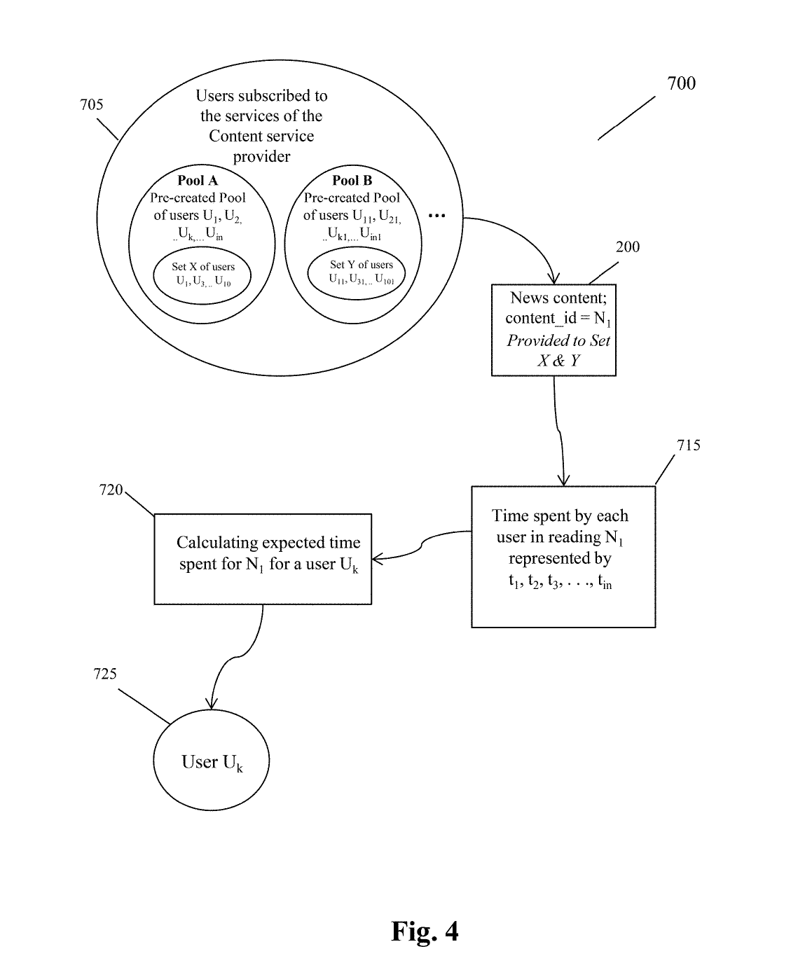

Referring to FIG. 4 of the accompanying drawings, there is provided a conceptual flow for determining the expected time spent for a news content for a user Uk belonging to POOL A of users. There is shown a universal set 705 which enlists all the users subscribed to the services of the content service provider. Within this set 705, there are provided two and more subsets defining the pool of users, such as Pool A and Pool B. It will be apparent to a person skilled in the art that these pools of users are created on the basis of similar taste or similar user profiles, or users having affinity or liking for similar category of news contents.

At a certain instance, news content N₁ is sent to a set X of users from Pool A and a set Y of users from Pool B. Based upon earlier explanation, the user activity data is received at the digital content server from the computing devices of sets X & Y of users from Pool A and Pool B.

From the user activity data, the actual time spent in reading the news content N₁, is retrieved for each of the users from sets X & Y at 715. Thereafter, from these actual time spents of the users, an expected time spent for a user Uk is derived at 720.

In an embodiment of the present disclosure, the expected time spent as calculated above is considered while ranking the news contents in the news feed for user Uk.

The above explains an exemplary embodiment for calculation of expected time spent for news content by a user. Depending upon the expected time spent for each news content, the news contents are ranked in the news feed to be transmitted to the user. In a way, the higher the expected time spent, the higher will be the ranking of the news content.

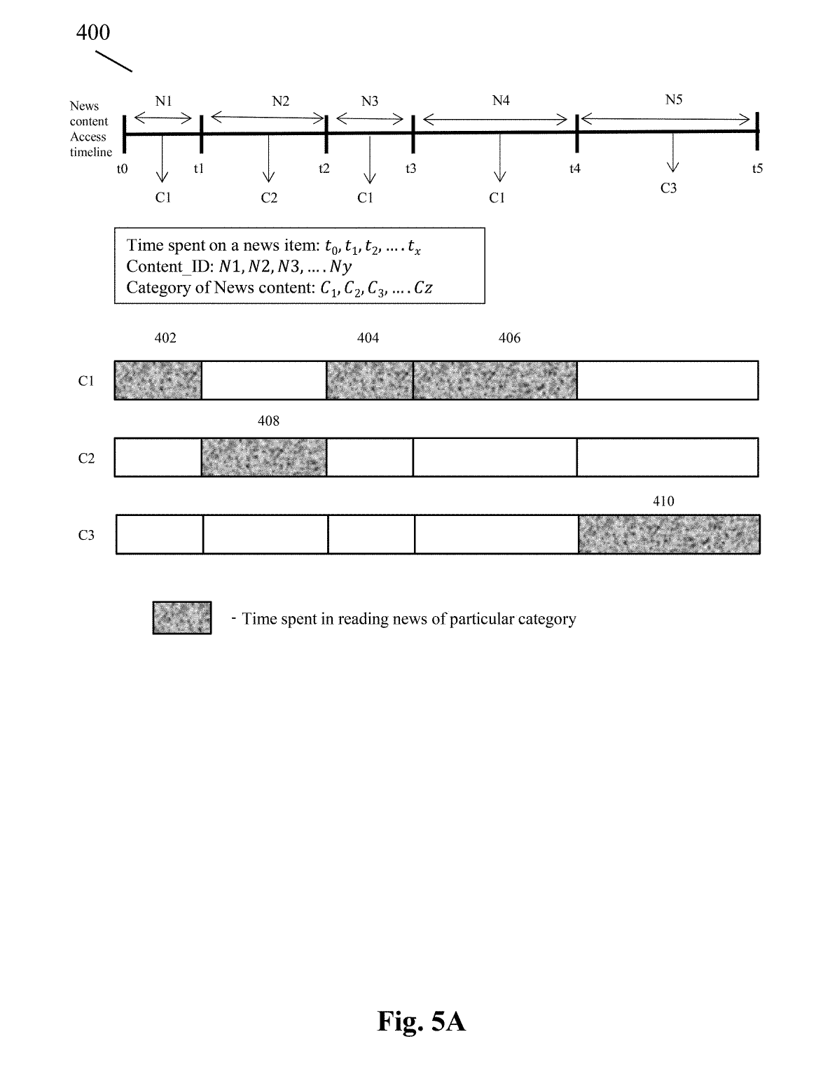

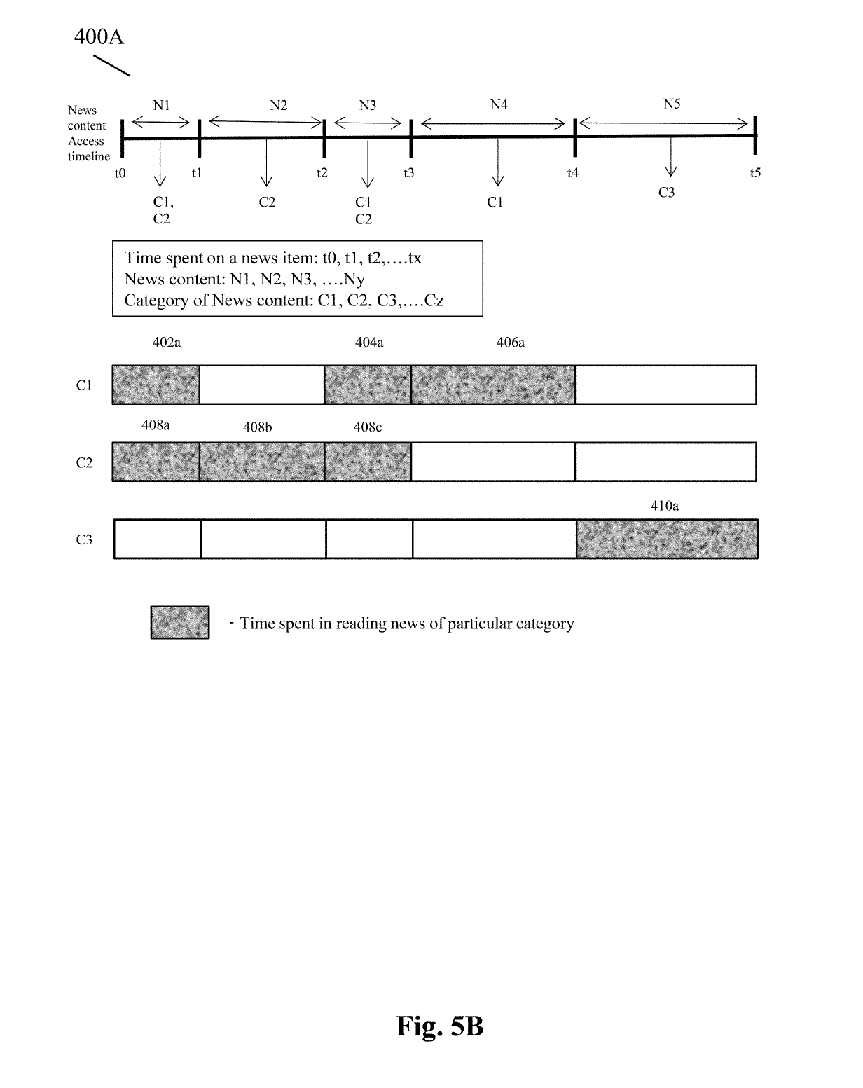

Referring again to time based criteria, FIG. 5A provides a conceptual illustration 400 for analysis of user preference on time based criteria. There is shown a graphical representation “News Content Access Timeline” in the said FIG. 5A. The News Content Access Timeline mainly comprises three parameters namely,

1) Time spent on a news content: t0, t1, t2, . . . tx,

2) News content: N1, N2, N3, . . . Ny and

3) Category of News content: C1, C2, C3, . . . Cz.

In a hypothetical situation, a user starts the software application in his computing device at a time t0. Then, the user goes through and reads news content N1 which belongs to, say, category C1. The user takes t1 time to read the news content N1. Then, the user reads news content N2 which belongs to, say category C2. The user takes t2 minus t1 time to read the news content N2.

Similarly, the user proceeds to read the news content N3 which belongs to, say, category C1. The user takes t3 minus t2 time to read the news content N3.

Such data related to time spent over these categories of news contents is tracked and collected by the tracking module at the end of the computing device.

Referring now to FIG. 5B, there is shown another conceptual illustration for analysis of user preference on time based criteria. There is shown a graphical representation “Short News Content Access Timeline” in the said FIG. 5B. In this figure, there are shown news content N1 which belongs to two categories C1 and C2, news content N2 belongs to category C2, news content N3 belongs to the categories C1 and C2, whereas N4 and N5 belongs to categories C1 and C3 respectively.

In an exemplary embodiment of the present invention, referring to FIG. 5B, it can be seen that the user has read news contents N1 and N3 which belong to both categories C1 and C2. Additionally, the user has also read the news content N2 which belongs to category C2. In such cases, it may be analyzed that the user is interested in reading news contents belonging to category C2 in comparison with category C1.

FIG. 6 of the accompanying drawings provide an illustration where the user 105 reads the news content 200 and clicks on the hyperlink 208 to read the full story of the news content 200. Once the user clicks on the hyperlink 208, the present systems and method are adapted to direct the user 105 to the original website which contains the content of the news content 200. The user 105 may further spend more time in reading the entire story on the original website. For example, in the present example of the news content 200, the user 105 clicks on the “Study by University of Michigan”. The present systems and methods are adapted to direct the user 105 to the original news link in the website of the “Reuters” as shown in 210.

Furthermore, such accessing of the original links of news contents in a particular category indicates positive preferences towards reading news contents from that particular category of news contents.

Moving further to FIG. 7, there is shown a pictorial representation of one of the criteria for analysis of user preferences on the basis of user activity data related to broadcasting the news content 200 of a particular category to other users 1051, 1052, . . . , 105n. These other users 1051, 1052, . . . , 105n are subscribed to the services of the content service provider and have the software application installed on their respective computing devices 1101, 1102, . . . , 110n for accessing the news content 200 for reading, liking, sharing and the like.

Once the user 105 reads the news content 200, he may desire to broadcast the same to other users 1051, 1052, . . . , 105n. The user 105 may click on the TOSS button 212 as shown in the FIG. 7. Once the user 105 clicks on the TOSS button 212, the news content 200 is broadcasted to the contacts present in the phonebook of the computing device of the user and also the Facebook and Twitter contacts of the user. Once the news content 200 is broadcasted, the users 1051, 1052, . . . , 105n receive notifications on their respective computing devices 1101, 1102, . . . , 110n and the news content 200 is presented on their devices.

The news content 200 is presented in the same predefined format to the other users 1051, 1052, . . . 105n.

Such criteria of the user broadcasting the news content to the other users is considered for analyzing the user preferences for particular user.

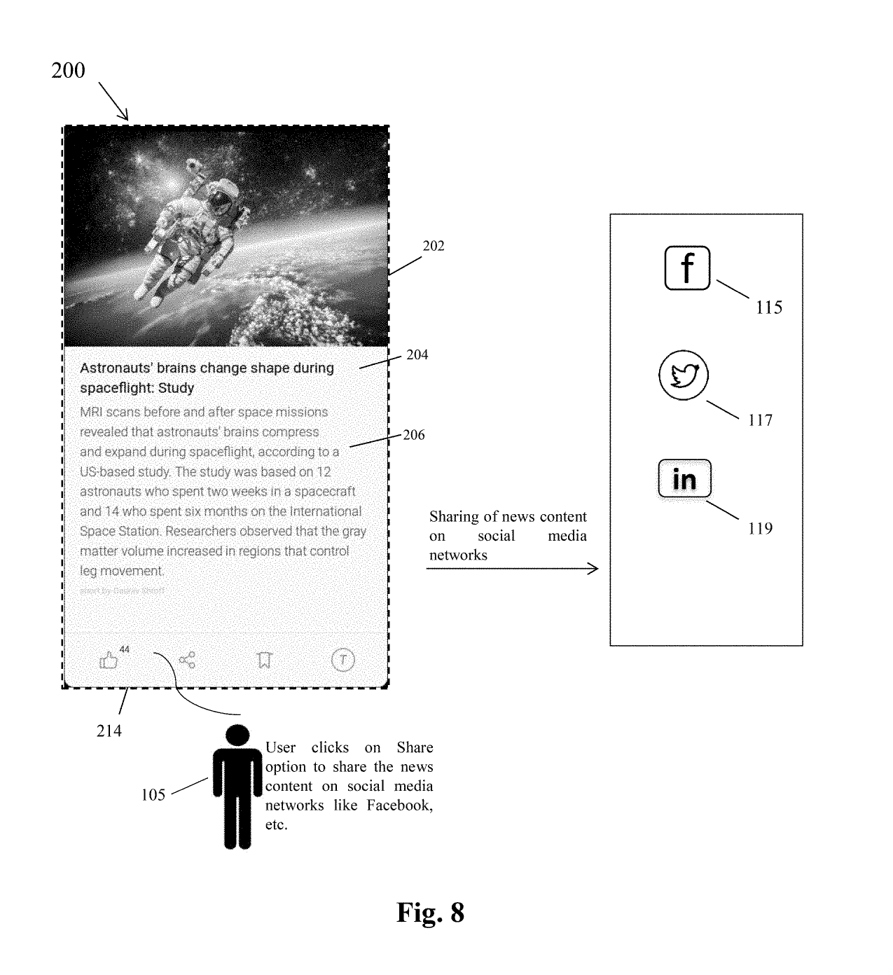

Referring to FIG. 8, there is shown another illustration for the analysis of user preferences where a user 105 likes or shares a news content belonging to a particular category over social media platforms. After the user 105 reads and wants to share the news content 200, the user 105 clicks on the Share button 214 as shown in the user interface.

Once the share button 214 is clicked, the user 105 is prompted to select the social media platforms 115, 117, 119 on which the user wants to share the news content 200. Upon such selection, the news content 200 is then shared on one or all of the social media platforms 115, 117, 119. The disclosed examples of social media platforms should not be construed as a limitation; there may be other social media platforms for sharing the news content.

Such data related to the user sharing the news content over social media platforms is tracked, collected by the tracking module at the end of the computing device and transmitted to the digital content server.

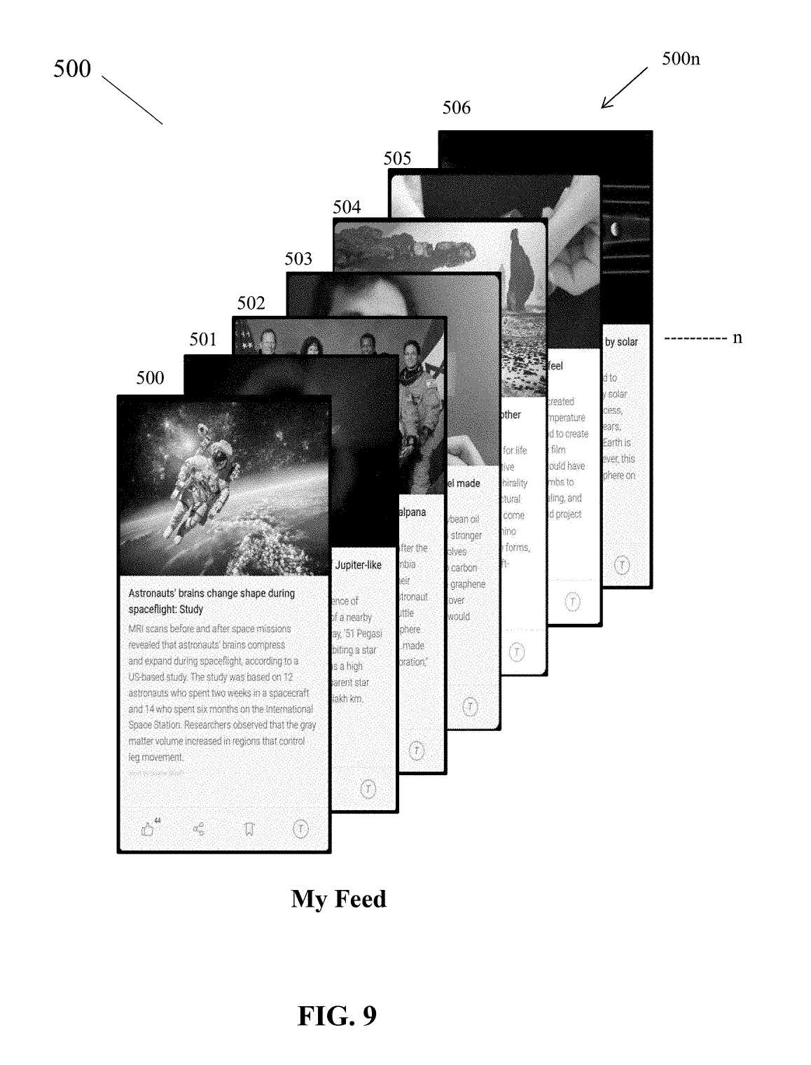

FIG. 9 illustrates a schematic diagram of news feed with various digital content ranked according to the algorithms as disclosed in the present patent application. As shown in the said FIG. 9, the news feed 500 includes plurality of digital contents 500, 501, 502, 503, 504, 505, 506, 500n compiled based on the algorithms disclosed in the patent application.

However, the above explanation is an exemplary embodiment of the present invention and this should not be construed as a limitation to the disclosure. There may be other possible analytical methods for analyzing the user preferences.

FIG. 10 illustrates the architecture of a computing device 110 being used by a user 105. The said architecture comprises a network interface 610, a Random Access Memory (RAM) 615, a Read only Memory (ROM) 625, a Mass Storage 630, a Central Processing Unit (CPU) 635 and an Input/Output interface 640. The I/O interface 640 is further coupled with a display unit 645, a keyboard 650, a mouse 655 and a removable media 660. The said computing device 110 is connected to the network 120 with the help of network interface 610. These should not be taken as a limitation of the disclosed computing device as there may be additional components in the architecture.

The present systems and methods are unique and novel. The present systems and methods are capable of providing personalized news feed to a user and thereby apprise the user with news contents of his interest. The present systems and methods are capable of transmitting and displaying the news content in a specific format. Moreover, the short news content is displayed on the computing device in the said format where there is no need for a user to click on a certain URL and read the news.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

We claim:

1. A computer implemented method for providing personalized news feed comprising one or more news content on a mobile application installed in a computing device of a user, the said mobile application comprising computer readable instructions for accessing the news feed, the computing device being communicably coupled to a digital content server which stores a plurality of news contents pre-stored in the said digital content server, the method comprising:
receiving user activity data at the digital content server from the computing device, wherein the user activity data is collected at the computing device;
determining user preferences for one or more category of the one or more news content depending upon the user activity data, wherein the one or more news content is taken from the plurality of news contents pre-stored in a database at the digital content server;
ranking the one or more news content to compile the news feed, ranking being done on basis of user preferences for each of the one or more news content; and
transmitting the news feed to the computing device of the user, wherein the transmittal of the news feed takes place on a request from the computing device.

2. The computer implemented method as claimed in claim 1, wherein the user activity data comprises a unique device_id associated with the computing device and content_id associated with each of the news contents accessed on the said computing device.

3. The computer implemented method as claimed in claim 1, wherein the user activity data comprises time spent by the user for previously accessed news content.

4. The computer implemented method as claimed in claim 1, wherein the user activity data comprises information about whether previously accessed news content has been shared or liked or broadcasted via the computing device.

5. The computer implemented method as claimed in claim 1, wherein the user activity data is used to determine one or more categories of news contents relevant for the user.

6. The computer implemented method as claimed in claim 1, wherein determining the user preferences comprises generating user affinity for a category of one or more news content, the user affinity being generated based on a predefined user affinity formula.

7. The computer implemented method as claimed in claim 6, wherein the user affinity is a parameter to determine chances of the user reading the news content.

8. The computer implemented method as claimed in claim 1, wherein ranking of the news contents in the news feed depends on an estimated time spent for one or more news content by the user.

9. The computer implemented method as claimed in claim 1, wherein the ranking of the one or more news contents in the news feed depends upon an editor score wherein the editor score is provided by an editor team having human interfaces.

10. The computer implemented method as claimed in claim 1, wherein the ranking of the one or more news contents in the news feed is done on basis of an expected time spent for one or more news content for the user.

11. The computer implemented method as claimed in claim 10, wherein the expected time spent for one or more news content for the user is calculated on the basis of actual time spent by users belonging to a pool of users.

12. The computer implemented method as claimed in claim 11, wherein the pool of users is created on the basis of users sharing similar interest in categories of news contents.

13. The computer implemented method as claimed in claim 1, wherein the news content comprises at least one textual content, an image content, a video content, an audio content, or a Graphics Interchange Format (GIF).

14. The computer implemented method as claimed in claim 1, wherein the computing device is a smart phone.

15. A system for providing personalized news feed on a mobile application installed in a computing device of a user, the said mobile application comprising computer readable instructions for accessing the news feed, the computing device being communicably coupled to a digital content server which stores a plurality of news contents pre-stored in the said digital content server, the digital content server comprising one or more processors capable of executing instructions comprising—
receiving user activity data at the digital content server from the computing device wherein the user activity data is collected by a Tracking module at the computing device,
determining user preferences by a Preference Determiner for one or more category of one or more news content depending upon the user activity data, wherein the one or more news content is taken from a plurality of news contents pre-stored in a database at the digital content server;
ranking the one or more news content by a Ranking module to compile the news feed, ranking being done on basis of user preferences for each of the one or more news content, and
transmitting the news feed by a Transmitting module to the computing device of the user, wherein the transmittal of the news feed takes place on a request from the computing device.

16. The system as claimed in claim 15, wherein the user activity data comprises a unique device_id associated with the computing device and content_id associated with each of the news contents accessed on the computing device.

17. The system as claimed in claim 15, wherein the user activity data comprises time spent for previously accessed news content.

18. The system as claimed in claim 15, wherein the user activity data comprises information about whether previously accessed news content has been shared or liked or broadcasted via the computing device.

19. The system as claimed in claim 15, wherein determining the user preferences comprises generating user affinity for a category of one or more news content.

20. The system as claimed in claim 19, wherein the user affinity is a parameter to determine chances of the user reading the news content.

21. The system as claimed in claim 15, wherein ranking of the news contents in the news feed depends on an estimated time spent for one or more news content by the user.

22. The system as claimed in claim 15, wherein the ranking of the one or more news contents depends upon an editor score wherein the editor score is provided by an editor team having human interfaces.

23. The system as claimed in claim 15, wherein the ranking of the one or more news contents is done on basis of an expected time spent for one or more news content for the user.

24. The system as claimed in claim 23, wherein the expected time spent for one or more news content for the user is calculated on the basis of actual time spent by users belonging to a pool of users.

25. The system as claimed in claim 24, wherein the pool of users is created on the basis of users sharing similar interest in categories of news contents.

26. The system as claimed in claim 15, wherein the news content comprises at least one textual content, an image content, a video content, an audio content, or a Graphics Interchange Format (GIF).
